(19) United States
(12) Patent Application Publication
(10) Pub. No.: US 2015/0075557 A1
(43) Pub. Date: Mar. 19, 2015

(54) Cleaning Mechanisms for Optical Elements

(71) Applicant: Schlumberger Technology Corporation, Sugar Land, TX (US)

(72) Inventor: Theodorus Tjhang, Sagamihara-shi (JP)

(73) Assignee: Schlumberger Technology Corporation, Sugar Land, TX (US)

(21) Appl. No.: 14/031,048

(22) Filed: Sep. 19, 2013

(51) Int. Cl. B08B 7/02; E21B 37/00; B08B 3/02

(52) U.S. Cl. CPC B08B 7/028; B08B 3/02; E21B 37/00
USPC 134/1; 134/200; 15/316.1; 134/18

(57) ABSTRACT

Cleaning mechanisms for optical elements are disclosed herein. Example apparatus disclosed herein to clean an optical element can include a cover positionable over a first side of the optical element. In some examples, the cover is controllable to transition between a first position and a second position. For example, the cover can form a gap between a first side of the optical element and the cover when the cover is in the first position, and the cover can provide the optical element with access to a field-of-view when the cover is in the second position. Such example apparatus can also include a flushing assembly controllable to inject cleaning fluid into the gap when the cover is in the first position. In some examples, the flushing assembly also includes a valve that is controllable to permit the cleaning fluid to exit the gap after having been injected into the gap.

### FIELD OF THE DISCLOSURE

This disclosure relates generally to optics and, more particularly, to cleaning mechanisms for optical elements.

### BACKGROUND

In many oilfield environments, such as deepwater and subterranean drilling environments, remote measurement and logging tools can provide useful information concerning the characteristics of geological formations, fluid flows in the geological formations, objects present in a formation and/or a borehole, etc. Also, remotely controlled equipment operating in oilfield and/or other remote exploration environments, such as manipulators, robotic vehicles, etc., may utilize one or more tools to gather information concerning the environment in which the equipment is operating. Some such tools may include one or more optical elements to enable viewing of the remote environment, gathering of image data for processing by one or more suitable algorithms, etc. In some scenarios, the optical element(s) included in a tool may become dirty due to contact with fluids and/or other material in the remote environment, thereby degrading the imaging information collected via the optical element(s).

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Example methods and systems disclosed herein relate generally to optics and, more particularly, to cleaning mechanisms for optical elements. Disclosed example apparatus to clean an optical element can include a cover positionable over a first side of the optical element. In some examples, the cover is controllable to transition between a first position and a second position. For example, the cover can form a gap between a first side of the optical element and the cover when the cover is in the first position, and the cover can provide the optical element with access to a field-of-view when the cover is in the second position. Such example apparatus can also include a flushing assembly controllable to inject cleaning fluid into the gap when the cover is in the first position. In some examples, the flushing assembly also includes a valve that is controllable to permit the cleaning fluid to exit the gap after having been injected into the gap.

Disclosed example methods to clean an optical element can include electronically controlling a cover positioned over a first side of the optical element to cause the cover to transition from a second position providing the optical element with access to a field-of-view to a first position forming a gap between a first side of the optical element and the cover. Such example methods can also include electronically controlling a flushing assembly to cause the flushing assembly to (1) inject cleaning fluid into the gap when the cover is in the first position, and (2) permit the cleaning fluid to exit the gap via a valve after the cleaning fluid has been injected into the gap.

### BRIEF DESCRIPTION OF THE DRAWINGS

Example cleaning mechanisms for optical elements are described with reference to the following figures. Where possible, the same numbers are used throughout the figures to reference like features and components.

FIG. 1 is a block diagram illustrating an example wellsite system in which an example optical element cleaning mechanism as disclosed herein may be used.

FIG. 2 is a block diagram illustrating an example sampling-while-drilling logging device in which an example optical element cleaning mechanism as disclosed herein may be used.

FIG. 3 is a block diagram illustrating an example imaging-based remote control system including an example remotely operated vehicle in which an example optical element cleaning mechanism as disclosed herein may be used.

FIG. 4 is a block diagram illustrating a first example optical element cleaning mechanism that may be used in the example systems of FIGS. 1 and/or 3, and/or in the example device of FIG. 2.

FIG. 5 is a block diagram illustrating a first example optical element cleaning mechanism that may be used in the example systems of FIGS. 1 and/or 3, and/or in the example device of FIG. 2.

FIG. 6 is a block diagram illustrating an example operation of the optical element cleaning mechanisms of FIGS. 4 and/or 5.

FIG. 7 illustrates an example cover that may be used to implement the optical element cleaning mechanisms of FIGS. 4 and/or 5.

FIGS. 8-10 are flowcharts representative of example processes that may be performed to control the optical element cleaning mechanisms of FIGS. 4 and/or 5.

FIG. 11 is a block diagram of an example processing system that may execute example machine readable instructions used to implement one or more of the processes of FIGS. 8-10 to control the optical element cleaning mechanisms of FIGS. 4 and/or 5.

### DETAILED DESCRIPTION

In the following detailed description, reference is made to the accompanying drawings, which form a part hereof, and within which are shown by way of illustration specific embodiments by which the invention may be practiced. It is to be understood that other embodiments may be utilized and structural changes may be made without departing from the scope of the disclosure.

As noted above, many tools used in oilfield and/or other remote exploration environments contain optical elements. Such optical elements can include, for example, lenses, windows, fiber optics, minors, etc. As further noted above, in some scenarios, such as when the optical element(s) of such tools come into contact with downhole fluid(s), the optical element(s) can become dirty. Prior techniques for maintaining the cleanliness of an optical element in such environments include coating the optical element with a special surfactant composition to repel oil or other downhole fluids. However, these prior techniques generally protect the optical element for a limited amount of time and for a particular type of downhole fluid. For example, if the optical element comes into contact with a different type of downhole fluid than what the surfactant composition is designed to repel, the optical element can become dirty in a relatively short time and reduce the visibility achievable by the optical element. In that case, cleaning of the optical element may then involve pulling the tool out of the remote environment and performing manual cleaning of the optical element, which may cause operational delays in the field.

The example optical element cleaning mechanisms disclosed herein can overcome at least some of the limitations associated with the foregoing prior techniques. For example, such disclosed optical element cleaning mechanisms can provide effective cleaning of optical elements for any amount of time and without being limited to a particular type of contaminating fluid. Furthermore, such disclosed optical element cleaning mechanisms can improve upon prior ultrasonic cleaning techniques that have been developed for cleaning optical windows and for clean marine fouling material from submerged surfaces.

Example apparatus disclosed herein to clean an optical element can include a cover positionable over a first side of the optical element. For example, the optical element can be a lens, a window, a mirror, a fiber optic cable, etc., or any combination thereof. In some examples, the cover is controllable to transition between a first position and a second position. For example, the cover can form a gap between a first side (e.g., a first surface) of the optical element and the cover when the cover is in the first position, and the cover can provide the optical element with access to a field-of-view when the cover is in the second position. Such example apparatus can also include a flushing assembly controllable to inject cleaning fluid into the gap when the cover is in the first position. For example, the cleaning fluid can be water, air, a noncombustible gas, a solvent, etc., or any combination thereof, and may include particles that are mixed with the cleaning fluid prior to the cleaning fluid being injected into the gap. In some examples, the flushing assembly also includes a valve that is controllable to permit the cleaning fluid to exit the gap after having been injected into the gap. In some examples, the optical element, the cover and the flushing assembly are included in a tool that is positionable downhole in a formation.

In some such example apparatus, the flushing assembly further includes a first nozzle through which the cleaning fluid is to be injected into the gap, and a second nozzle through which the cleaning fluid is to exit the gap. In some examples, the flushing assembly is controllable to (1) inject the cleaning fluid into the gap for a first time period beginning after the cover has transitioned to the first position, (2) stop injection of the fluid into the gap for a second time period beginning after the first time period ends, and (3) open the valve to permit the cleaning fluid to exit the gap after the second time period ends. In other examples, the flushing assembly is controllable to inject the cleaning fluid into the gap and to permit the cleaning fluid to exit the gap via the valve continuously after the cover has transitioned to the first position.

In some such example apparatus, the cover includes a diaphragm controllable to change an aperture over the first side of the optical element. For example, the diaphragm can increase a size of the aperture when the cover is controlled to transition from the first position to the second position, and the diaphragm can decrease the size of the aperture when the cover is controlled to transition from the second position to the first position.

Some such example apparatus further include an ultrasonic transducer positionable to focus an ultrasonic beam on the first side of the optical element. In some such examples, the ultrasonic transducer is positioned on the cover and is arranged to focus the ultrasonic beam on the first side of the optical element when the cover is in the first position. In other such examples, the optical element is included in a housing, and the ultrasonic transducer is positioned on a wall of the housing. Furthermore, in some such examples, the flushing assembly is controllable to (1) inject the cleaning fluid into the gap for a first time period beginning after the cover has transitioned to the first position, (2) stop injection of the fluid into the gap for a second time period beginning after the first time period ends, and (3) open the valve to permit the cleaning fluid to exit the gap after the second time period ends, and the ultrasonic transducer is controllable to (4) emit the ultrasonic beam during the second time period. Furthermore, in other such examples, the flushing assembly is controllable to inject the cleaning fluid into the gap and to permit the cleaning fluid to exit the gap via the valve continuously after the cover has transitioned to the first position, and the ultrasonic transducer is controllable to emit the ultrasonic beam after the cover has transitioned to the first position.

Some such example apparatus also include a heating element to heat the cleaning fluid prior to the cleaning fluid being injected into the gap.

Example methods disclosed herein to clean an optical element can include electronically controlling a cover positioned over a first side of the optical element to cause the cover to transition from a second position providing the optical element with access to a field-of-view to a first position forming a gap between a first side of the optical element and the cover. Such example methods can also include electronically controlling a flushing assembly to cause the flushing assembly to (1) inject cleaning fluid into the gap when the cover is in the first position, and (2) permit the cleaning fluid to exit the gap via a valve after the cleaning fluid has been injected into the gap.

In some such example methods, controlling the cover includes controlling a diaphragm included in the cover to cause the diaphragm to decrease a size of an aperture over the first side of the optical element.

In some such example methods, controlling the flushing assembly includes causing the flushing assembly to perform operations including (1) injecting the cleaning fluid into the gap for a first time period beginning after the cover has transitioned to the first position, (2) stopping injection of the fluid into the gap for a second time period beginning after the first time period ends, and (3) opening the valve to permit the cleaning fluid to exit the gap after the second time period ends.

In some such example methods, controlling the flushing assembly includes causing the flushing assembly to perform operations including injecting the cleaning fluid into the gap and permitting the cleaning fluid to exit the gap via the valve continuously after the cover has transitioned to the first position.

Some such example methods further include controlling an ultrasonic transducer to cause the ultrasonic transducer to emit an ultrasonic beam focused on the first side of the optical element. In some such example methods, controlling the flushing assembly includes causing the flushing assembly to perform first operations including (1) injecting the cleaning fluid into the gap for a first time period beginning after the cover has transitioned to the first position, (2) stopping injection of the fluid into the gap for a second time period beginning after the first time period ends, and (3) opening the valve to permit the cleaning fluid to exit the gap after the second time period ends, and controlling the ultrasonic transducer comprises causing the ultrasonic transducer to perform second operations including (4) emitting the ultrasonic beam during the second time period. In other such example methods, controlling the flushing assembly includes causing the flushing assembly to perform first operations including injecting the cleaning fluid into the gap and permitting the cleaning fluid to exit the gap via the valve continuously after the cover has transitioned to the first position, and controlling the ultrasonic transducer comprises causing the ultrasonic transducer to perform second operations including emitting the ultrasonic beam after the cover has transitioned to the first position.

These and other example methods, apparatus, systems and articles of manufacture (e.g., storage media) to implement cleaning mechanisms for optical elements are disclosed in greater detail below.

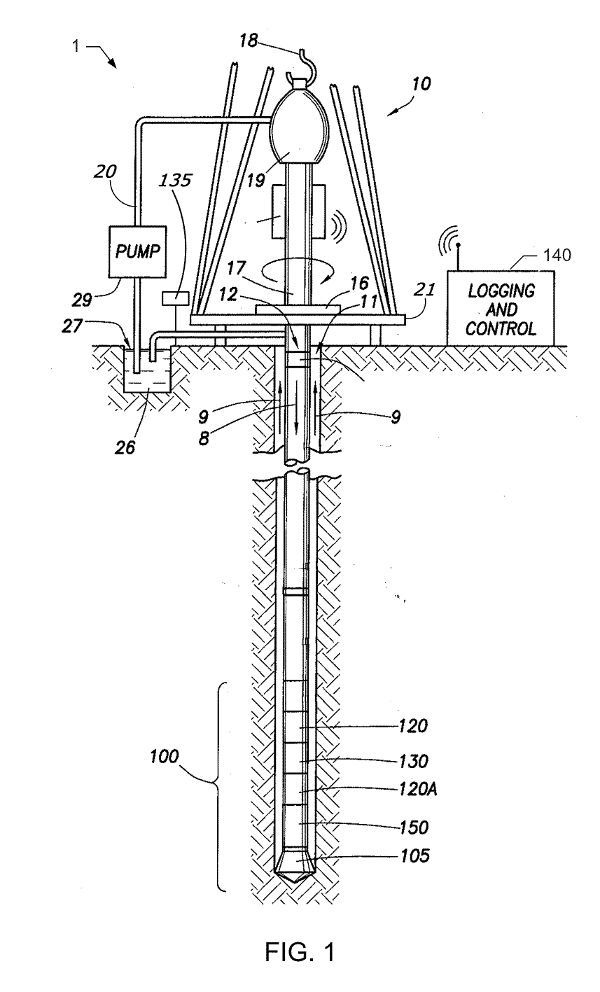

Turning to the figures, FIG. 1 illustrates an example wellsite system 1 in which the example optical element cleaning mechanisms disclosed herein can be employed. The wellsite can be onshore or offshore. In this example system, a borehole 11 is formed in subsurface formations by rotary drilling, whereas other example systems can use directional drilling.

A drillstring 12 is suspended within the borehole 11 and has a bottom hole assembly 100 that includes a drill bit 105 at its lower end. The surface system includes platform and derrick assembly 10 positioned over the borehole 11, the assembly 10 including a rotary table 16, kelly 17, hook 18 and rotary swivel 19. In an example, the drill string 12 is suspended from a lifting gear (not shown) via the hook 18, with the lifting gear being coupled to a mast (not shown) rising above the surface. An example lifting gear includes a crown block whose axis is affixed to the top of the mast, a vertically traveling block to which the hook 18 is attached, and a cable passing through the crown block and the vertically traveling block. In such an example, one end of the cable is affixed to an anchor point, whereas the other end is affixed to a winch to raise and lower the hook 18 and the drillstring 12 coupled thereto. The drillstring 12 is formed of drill pipes screwed one to another.

The drillstring 12 may be raised and lowered by turning the lifting gear with the winch. In some scenarios, drill pipe raising and lowering operations involve the drillstring 12 being unhooked temporarily from the lifting gear. In such scenarios, the drillstring 12 can be supported by blocking it with wedges in a conical recess of the rotary table 16, which is mounted on a platform 21 through which the drillstring 12 passes.

In the illustrated example, the drillstring 12 is rotated by the rotary table 16, energized by means not shown, which engages the kelly 17 at the upper end of the drillstring 12. The drillstring 12 is suspended from the hook 18, attached to a traveling block (also not shown), through the kelly 17 and the rotary swivel 19, which permits rotation of the drillstring 12 relative to the hook 18. In some examples, a top drive system could be used.

In the illustrated example, the surface system further includes drilling fluid or mud 26 stored in a pit 27 formed at the well site. A pump 29 delivers the drilling fluid 26 to the interior of the drillstring 12 via a hose 20 coupled to a port in the swivel 19, causing the drilling fluid to flow downwardly through the drillstring 12 as indicated by the directional arrow 8. The drilling fluid exits the drillstring 12 via ports in the drill bit 105, and then circulates upwardly through the annulus region between the outside of the drillstring and the wall of the borehole, as indicated by the directional arrows 9. In this manner, the drilling fluid lubricates the drill bit 105 and carries formation cuttings up to the surface as it is returned to the pit 27 for recirculation.

The bottom hole assembly 100 includes one or more specially-made drill collars near the drill bit 105. Each such drill collar has one or more logging devices mounted on or in it, thereby allowing downhole drilling conditions and/or various characteristic properties of the geological formation (e.g., such as layers of rock or other material) intersected by the borehole 11 to be measured as the borehole 11 is deepened. In particular, the bottom hole assembly 100 of the illustrated example system 1 includes a logging-while-drilling (LWD) module 120, a measuring-while-drilling (MWD) module 130, a roto-steerable system and motor 150, and the drill bit 105.

The LWD module 120 is housed in a drill collar and can contain one or a plurality of logging tools. It will also be understood that more than one LWD and/or MWD module can be employed, e.g. as represented at 120A. (References, throughout, to a module at the position of 120 can mean a module at the position of 120A as well.) The LWD module 120 includes capabilities for measuring, processing, and storing information, as well as for communicating with the surface equipment.

The MWD module 130 is also housed in a drill collar and can contain one or more devices for measuring characteristics of the drillstring 12 and drill bit 105. The MWD module 130 further includes an apparatus (not shown) for generating electrical power to the downhole system. This may include a mud turbine generator powered by the flow of the drilling fluid, it being understood that other power and/or battery systems may be employed. In the illustrated example, the MWD module 130 includes one or more of the following types of measuring devices: a weight-on-bit measuring device, a torque measuring device, a vibration measuring device, a shock measuring device, a stick slip measuring device, a direction measuring device, and an inclination measuring device.

The wellsite system 1 also includes an example surface monitoring tool 135 to monitor operation of one or more surface portions of the example wellsite system 1. For example, the surface monitoring tool 135 can be arranged to monitor the operation of and/or condition of the platform and derrick assembly 10, the rotary table 16, the kelly 17, the hook 18, the rotary swivel 19, the platform 21, the hose 20, the pump 29, the pit 27, etc., and/or any combination thereof. The wellsite system 1 further includes a logging and control unit 140 communicably coupled in any appropriate manner to the LWD module 120/120A, the MWD module 130 and/or the surface monitoring tool 135. In the illustrated example, the LWD module 120/120A, the MWD module 130 and/or the surface monitoring tool 135, possibly in conjunction with the logging and control unit 140, implement optical element cleaning mechanisms in accordance with the examples disclosed herein.

For example, the LWD module 120/120A and/or the MWD module 130 may include one or more optical elements to permit imaging information to be obtained from the downhole environment. Similarly, the surface monitoring tool 135 may include one or more optical elements to permit imaging information to be obtained from the surface environment. The LWD module 120/120A, the MWD module 130 and/or the surface monitoring tool 135 may also report such imaging information to the logging and control unit 140 for viewing, analysis, processing, etc. In some examples, one or more of the LWD module 120/120A, the MWD module 130 and/or the surface monitoring tool 135 may include example optical element cleaning mechanisms to clean their respective optical element(s) in accordance with one or more of the example optical element cleaning methods disclosed herein. Examples of such optical element cleaning mechanisms and methods for use in the example wellsite system 1 and/or in other remote environments are described in greater detail below. Also, although some of the example optical element cleaning techniques disclosed herein are described in the context of LWD and MWD applications and other remote sensing applications, the example optical element cleaning techniques are not limited thereto. Instead, optical element cleaning techniques as disclosed herein can also be used in other applications, such as wireline logging, production logging, permanent logging, fluid analysis, formation evaluation, sampling-while-drilling, etc.

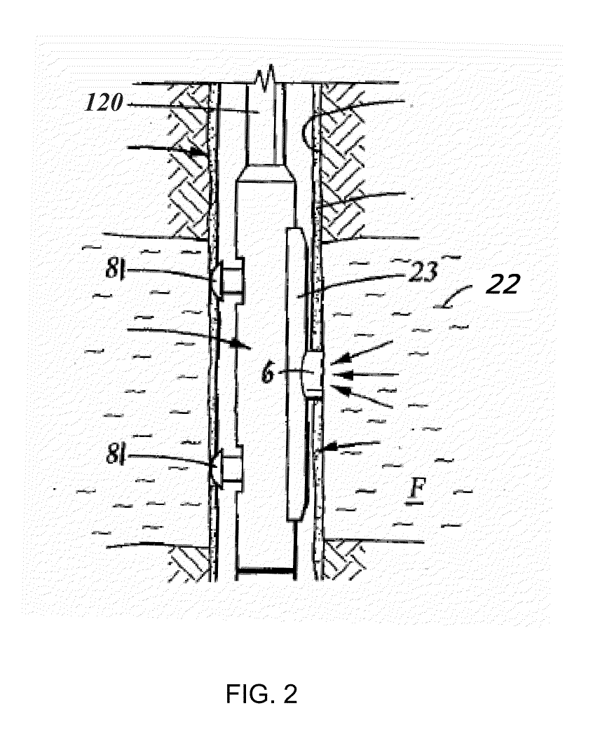

For example, FIG. 2 is a simplified diagram of an example sampling-while-drilling logging device of a type described in U.S. Pat. No. 7,114,562, incorporated herein by reference, utilized as the LWD tool 120 or part of an LWD tool suite 120A, in which optical element cleaning techniques as disclosed herein can be used. The LWD tool 120 is provided with a probe 6 for establishing fluid communication with the formation and drawing the fluid 22 into the tool, as indicated by the arrows. The probe may be positioned in a stabilizer blade 23 of the LWD tool and extended therefrom to engage the borehole wall. The stabilizer blade 23 comprises one or more blades that are in contact with the borehole wall. Fluid drawn into the downhole tool using the probe 6 may be measured to determine, for example, pretest and/or pressure parameters. Additionally, the LWD tool 120 may be provided with devices, such as sample chambers, for collecting fluid samples for retrieval at the surface. Backup pistons 81 may also be provided to assist in applying force to push the drilling tool and/or probe against the borehole wall.

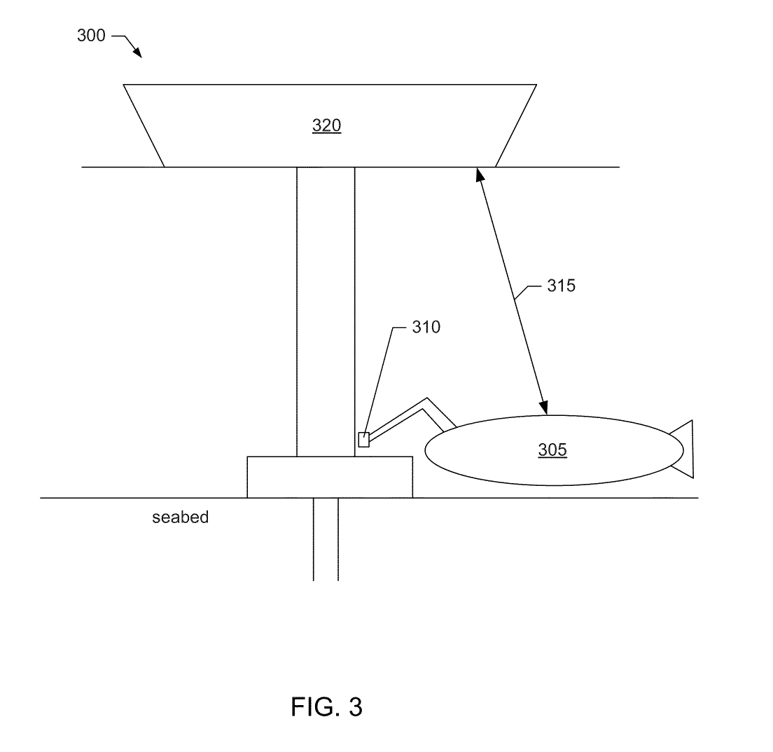

An example remote exploration system 300 including an example remotely operated vehicle (ROV) 305 having an example remotely controlled imaging tool 310 that may employ one or more of the example optical element cleaning techniques disclosed herein is illustrated in FIG. 3. In the illustrated example, the ROV 305 can be used for oilfield equipment maintenance, construction and/or observation in a deep sea environment, etc. The system 300 of FIG. 3 includes an example telemetry communication link 315 between the ROV 305 and an example drilling ship 320 at the surface. In the illustrated example, the imaging tool 310 includes one or more optical elements to obtain imaging information from the remote environment. As described in greater detail below, the imaging tool 310 can also include a disclosed example optical element cleaning mechanism to clean the optical element(s) of the imaging tool 310 in accordance with the optical element cleaning methods disclosed herein. Also, as described in greater detail below, such optical element cleaning methods may be performed autonomously at the imaging tool 310, or controlled via commands issued at the drilling ship 320 and conveyed to tool 310 via the telemetry communication link 315.

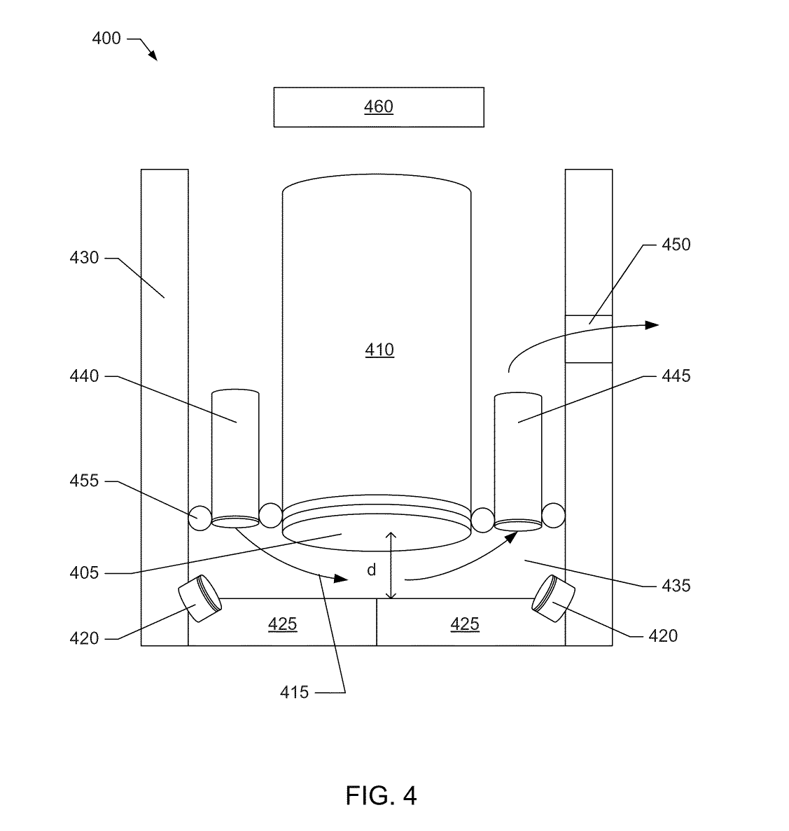

A block diagram of a first example optical element cleaning mechanism 400 that can be used to clean optical element(s) of, for example, one or more of the LWD module 120/120A, the MWD module 130, the surface monitoring tool 135, and/or the imaging tool 310 is illustrated in FIG. 4. In the illustrated example of FIG. 4, the optical element cleaning mechanism 400 is configured to clean an example optical element 405 of an example tool 410. For example, the optical element 405 can correspond to one or more of a camera lens, a window, a minor, a fiber optic cable, etc., or any combination thereof. The example tool 410 can correspond to, for example, the LWD module 120/120A, the MWD module 130, the surface monitoring tool 135, the imaging tool 310, etc. In the illustrated example of FIG. 4, the optical element 405 can come into contact with downhole fluid and/other sources of contamination.

The optical element cleaning mechanism 400 of the illustrated example uses example flushing fluid 415, possibly in combination with ultrasonic emissions from one or more example ultrasonic transducers 420, to clean the optical element 405. Moreover, the optical element cleaning mechanism 400 operates to form a cleaning region around the optical element 405 to thereby increase the effectiveness of the cleaning achievable by flowing the flushing fluid 415 over the optical element 405 and/or by directing ultrasonic emissions at the optical element 405.

For example, to form a cleaning region around the optical element 405, the optical element cleaning mechanism 400 includes an example cover 425 that is positionable over a first side (e.g., a first surface) of the optical element 405. The cover 425 of the illustrated example can be implemented by any type of cover or similar device that is controllable such that the cover 425 can transition between a first (e.g., closed) position and a second (e.g., open) position. For example, the cover 425 includes or is otherwise controllable via one or more actuators (not shown) to enable the cover 425 to transition between the first (e.g., closed) position and the second (e.g., open) position. Such actuator(s) may include, but are not limited to, one or more electromechanical actuators, one or more pneumatic actuators, one or more hydraulic actuators, etc., or any combination thereof.

In the illustrated example of FIG. 4, the cover 425 is affixed or otherwise coupled to an example housing 430 such that, when the cover 425 is in the first (e.g., closed) position, the cover 425 and housing 430 form a substantially confined cleaning area 435 around at least the first side of the optical element 405. In such examples, the housing 430 can be implemented by a housing of the tool 410, tubing extended down into the borehole in which the tool 410 is positioned, the formation wall of the borehole, etc., or any combination thereof. During operation of the tool 410 to obtain imaging information, the cover 425 is controlled to transition to the second (e.g., open) position to provide the optical element 405 with access to a field-of-view that allows the optical element 405 to view the environment outside the housing 430.

In some examples, when the cover 425 is in the second (e.g., open) position, the optical element 405 may come into contact with drilling fluid and/or other opaque fluid and/or other contaminants in the outside environment. Accordingly, the optical element cleaning mechanism 400 may include flushing jets (not shown) to propel flushing fluid into the field-of-view of the optical element 405 while the cover 425 is in the second (e.g., open) position to improve visibility while the optical element 405 is gathering imaging information. Examples of flushing techniques that may be used while cover 425 is in the second (e.g., open) position are disclosed in U.S. application Ser. No. 13/439,824, entitled “IMAGING METHODS AND SYSTEMS FOR CONTROLLING EQUIPMENT IN REMOTE ENVIRONMENTS” and filed on Apr. 4, 2013, which is incorporated by reference herein in its entirety.

In between times when the tool 410 is operated to obtain imaging information, there may be times at which the tool 410 may configured to be nonoperational to permit the tool 410 to be moved to another position, depth, etc. During such times, or whenever cleaning of the optical element 405 is to be performed, the cover 425 is controlled to transition to the first (e.g., closed) position to form the cleaning region 435 around the optical element 405. For example, the cleaning region 435 can be a substantially confined cavity characterized by a gap having distance, d, formed between a first side of the optical element 405 and the cover 425 when the cover 425 is in the first (e.g., closed) position. Accordingly, during time periods when the tool 410 is not being used to obtain imaging information, the cover 425 can be closed to avoid further contamination of the optical element 405.

Furthermore, the optical element cleaning mechanism 400 of the illustrated example includes an example flushing assembly having an example injector nozzle 440, an example exit nozzle 445 and an example exit valve 450. In the illustrated example of FIG. 4, the injector nozzle 440 can be implemented by any type of nozzle or similar device that permits the flushing (e.g., cleaning) fluid 415 to be injected or otherwise projected into the cleaning area 435 and into the gap that is formed after the cover 425 transitions into the first (e.g., closed) position. The exit nozzle 445 can be implemented by any type of nozzle or similar device that permits the injected flushing fluid 415, which may contain any contaminants removed from the optical element 405, to exit the gap and the cleaning area 435. The exit valve 450 can be implemented by any type of valve or similar device that permits the used flushing fluid 415 to be removed from the optical element cleaning mechanism 400. In some examples, any type of packing material 455 can be used to prevent the flushing (e.g., cleaning) fluid 415 from exiting the cleaning area 435, or to at least reduce the amount of flushing fluid 415 that can exit the cleaning area 435, except through the exit nozzle 445 while the cover 425 is in the first (e.g., closed) position.

In the illustrated example of FIG. 4, to clean the optical element 405, the cover 425 is controlled to transition into the first (e.g., closed) position to form a narrow gap (d) between at least a first side (e.g., a first surface) of the optical element 405 and the cover 425. The injector nozzle 440 then injects the flushing fluid 415 into the cleaning area 435 and, thus, the gap (d) formed after the cover 425 is closed. The narrow gap formed between the optical element 405 and the cover 425 when the cover 425 is closed causes the flow rate of the flushing fluid 415 across the optical element 405 to increase relative to when the cover 425 is opened. This increase in fluid flow rate can increase the effectiveness of the flushing fluid 415 for removing fluids (e.g., such as oil) and/or other contaminants from the surface of the optical element 405. In some examples, the valve 450 of the flushing assembly is controllable such that the valve 450 can be opened or closed to maintain a desired flow rate of flushing fluid 415 across the surface of the optical element 405. In other examples, the valve 450 is implemented by a port that, for example, permits fluid flow in one direction (e.g., out of the optical element cleaning mechanism 400) but not in another direction (e.g., into the optical element cleaning mechanism 400).

As mentioned above, the optical element cleaning mechanism 400 may include one or more ultrasonic transducers 420 to emit ultrasonic waves focused at the optical element 405. In the illustrated example, the ultrasonic transducers 420 are positioned on a wall of the housing 430 such that they are able to focus an ultrasonic beam on a first side (e.g., surface) of the optical element 405. The ultrasonic transducers 420 of the illustrated example generate ultrasonic waves in the flushing fluid 415 to clean the optical element 405. The narrow gap formed between the optical element 405 and the cover 425 when the cover 425 is closed can increase the effectiveness of the ultrasonic waves for cleaning the optical element 405 relative to when the cover 425 is opened.

For example, in a first example cleaning operation, after the cover 425 is controlled to transition into the first (e.g., closed) position to form the narrow gap (d), the injector nozzle 440 is controlled to cause the flushing fluid 415 to be injected into the cleaning area 435 and, thus, the gap (d), which may cause contaminants on the optical part 405 to be dislodged. The injector nozzle 440 continues to inject the flushing fluid 415 into the cleaning area 435 for a first time period. After the first time period ends, the injector nozzle 440 is controlled to stop further flushing fluid 415 from being injected into the cleaning area 435 for a second period of time. In some examples, if the ultrasonic transducer(s) 420 are present in the optical element cleaning mechanism 400, then the ultrasonic transducer(s) 420 are controlled to emit an ultrasonic beam (e.g., focused on the optical element 405) during this second time period to further cause any remaining contaminants on the optical part 405 to be dislodged. Then, after the second time period ends, the valve 450 is controlled to cause the valve 450 to open to permit the flushing fluid 415, which contains any contaminants dislodged from the optical part 405, to exit the gap and the cleaning area 435. If the ultrasonic transducer(s) 420 are present and were controlled to emit an ultrasonic beam during the second time period, then at the end of the second time period, the ultrasonic transducer(s) 420 is controlled to halt emission of the ultrasonic beam. Afterwards, the cover 425 may be controlled to transition into the second (e.g., open) position to permit the tool 410 to resume normal imaging operation.

As another example, in a second example cleaning operation, after the cover 425 is controlled to transition into the first (e.g., closed) position to form the narrow gap (d), the nozzles 440/445 and the valve 450 are controlled to cause the flushing fluid 415 to flow into the cleaning area 435 and, thus, into the gap and across the optical element 405 at a desired flow rate continuously (or almost continuously) while the cover 425 is closed, thereby causing contaminants on the optical part 405 to be dislodged. Also, if the ultrasonic transducer(s) 420 are present in the optical element cleaning mechanism 400, then the ultrasonic transducer(s) 420 can be controlled to emit an ultrasonic beam (e.g., focused on the optical element 405) while the cover 425 is closed, thereby further causing contaminants on the optical part 405 to be dislodged. After cleaning is complete, the cover 425 may be controlled to transition into the second (e.g., open) position to permit the tool 410 to resume normal imaging operation.

The flushing fluid 415 may correspond to any type of fluid, such as water, air, one or more solvents, etc., or any combination thereof. Furthermore, in some environments, such as when the optical element cleaning mechanism 400 is used in flammable environments, such as in the surface monitoring tool 135 of FIG. 1, the flushing fluid 415 may correspond to a noncombustible gas, such as carbon dioxide, nitrogen, etc., or any combination thereof. In some examples, particles may be mixed with the flushing fluid 415 (e.g., prior to injection into the cleaning area 435 and, thus, into the gap) to increase the cleaning effectiveness of the flushing fluid 415. Also, in some examples, the optical element cleaning mechanism 400 may include an example heating element (not shown) to heat the flushing fluid 415 (e.g., prior to injection into the cleaning area 435 and, thus, into the gap) to increase the cleaning effectiveness of the flushing fluid 415.

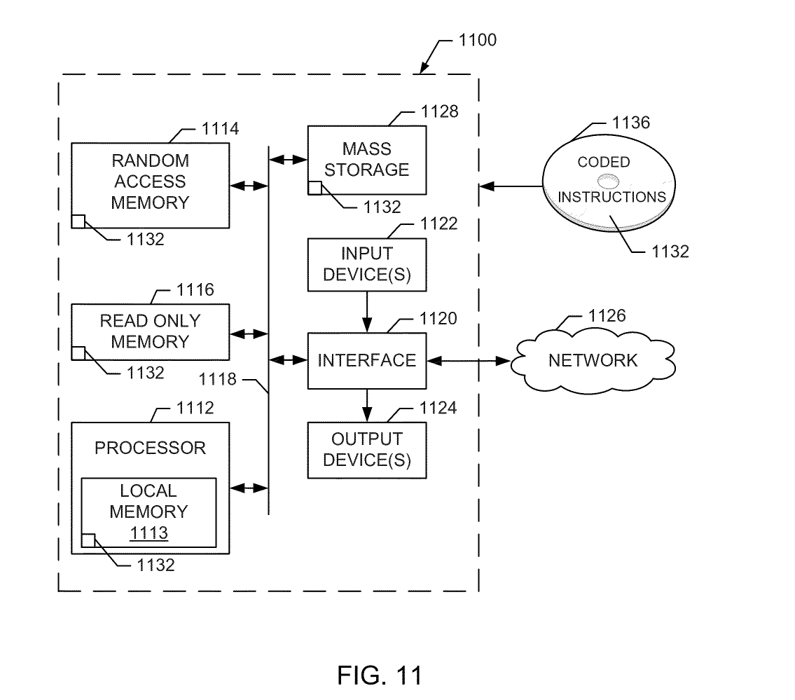

The example optical element cleaning mechanism 400 of FIG. 4 further includes an example controller 460 to control operation of one or more of the ultrasonic transducer(s) 420, the cover 425, the ports 440 and/or 445, and/or the valve 450. In some examples, the controller 460 can be implemented by any type of processor platform, such as the example processor platform 1100 of FIG. 11, which is described in greater detail below. In some examples, the controller 460 can be co-located with the optical element cleaning mechanism 400 and the tool 410 such that controller 460 performs autonomous control of the optical element cleaning mechanism 400 in accordance with one or more of the optical cleaning methods disclosed herein. In other examples, the controller 460 can be located remotely from the optical element cleaning mechanism 400 and the tool 410, such as at the logging and control unit 140 or in the 320, to permit remote control of the optical element cleaning mechanism 400 (e.g., via a telemetry link) in accordance with one or more of the optical cleaning methods disclosed herein.

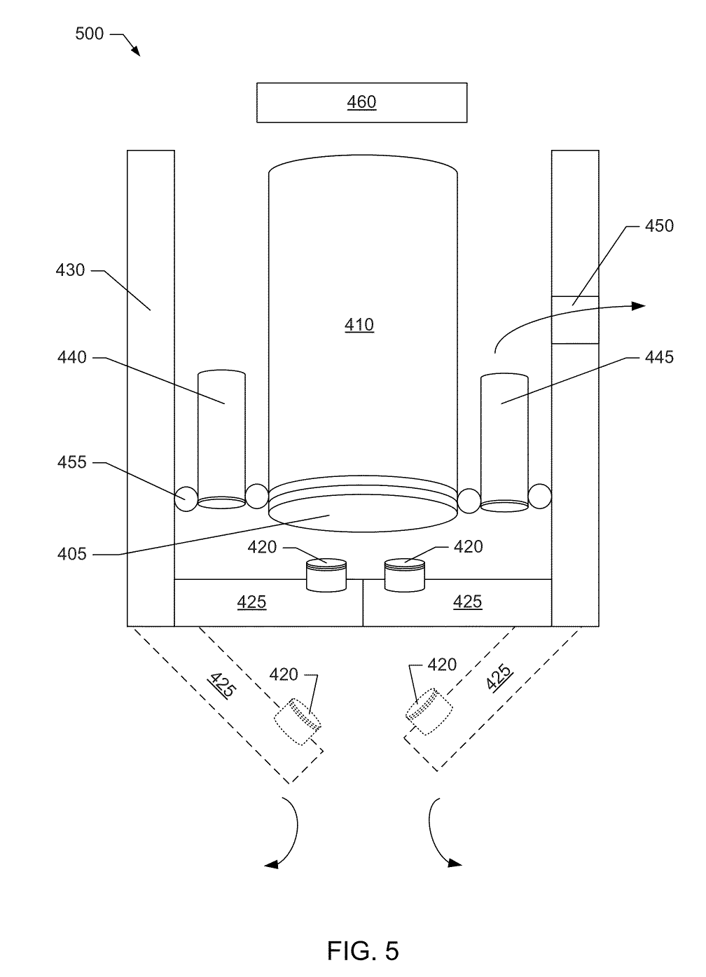

A block diagram of a second example optical element cleaning mechanism 500 that can be used to clean optical element(s) of, for example, one or more of the LWD module 120/120A, the MWD module 130, the surface monitoring tool 135, and/or the imaging tool 310 is illustrated in FIG. 5. The second example optical element cleaning mechanism 500 includes many elements in common with the first example optical element cleaning mechanism 400 of FIG. 4. As such, like elements in FIGS. 4 and 5 are labeled with the same reference numerals. The detailed descriptions of these like elements are provided above in connection with the discussion of FIG. 4 and, in the interest of brevity, are not repeated in the discussion of FIG. 5.

For example, the second example optical element cleaning mechanism 500 includes the example ultrasonic transducer(s) 420, the example cover 425, the example housing 430, the example injector nozzle 440, the example exit nozzle 445, the example valve 450, the example packing material 455 and the example controller 460, which are described above in connection with the first example optical element cleaning mechanism 400. FIG. 5 also illustrates the transitioning of the cover 425 from the first (e.g., closed) position, which is represented by solid lines, and the second (e.g., open) position, which is represented by dashed lines. Furthermore, in the second example optical element cleaning mechanism 500 of FIG. 5, the ultrasonic transducer(s) 420 are positioned on the cover 425, rather than on the housing 430 as in the first example optical element cleaning mechanism 400. For example, the ultrasonic transducer(s) 420 are positioned on the cover 425 of the optical element cleaning mechanism 500 such that the ultrasonic transducer(s) 420 are brought into close proximity to and become focused on the optical element 405 when the cover 425 is brought into the first (e.g., closed) position. In at least some examples, by positioning the ultrasonic transducer(s) 420 on the cover 425, the ultrasonic transducer(s) 420 can be positioned over and brought to within the distance, d, or less, from the optical element 405, which may improve the effectiveness of cleaning with the ultrasonic transducer(s) 420 relative to the positioning shown in the example of FIG. 4.

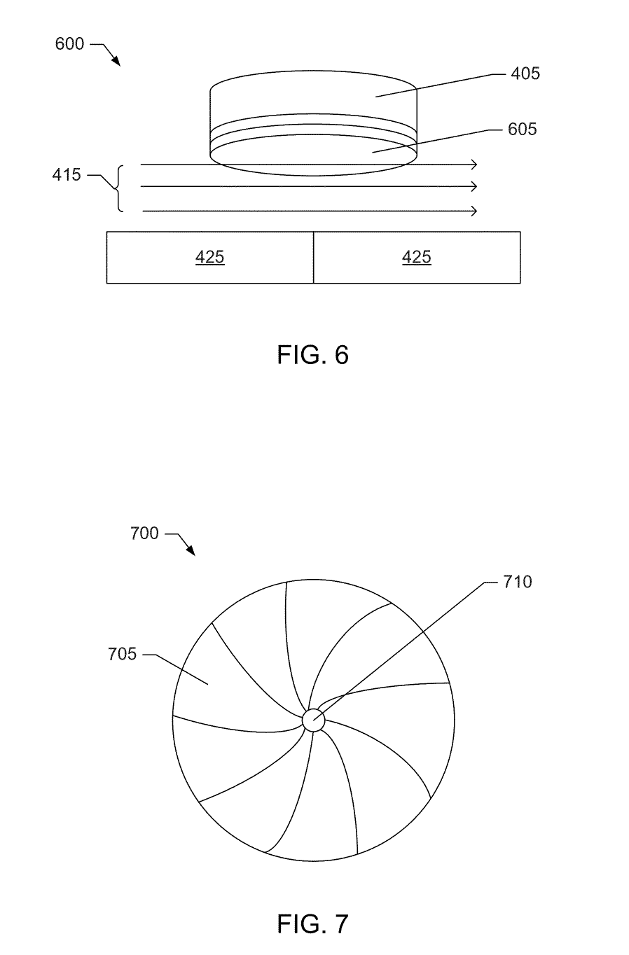

FIG. 6 depicts an example operation of the optical element cleaning mechanisms 400 and/or 500 during which the flushing fluid 415 is injected into the gap (d) formed between the optical element 405 and the cover 425 when the cover 425 is in the first (e.g., closed) position. As illustrated in the example of FIG. 6, when the cover 425 is in the first (e.g., closed) position, the flushing fluid 415 is caused to flow in a confined region across a surface 605 of the optical element 405. As noted above, injecting the flushing fluid 415 into such a confined region causes the flow rate of the fluid to increase, thereby enhancing the effectiveness of the fluid 415 for cleaning the surface 605 of the optical element 405.

An example cover 700 that may be used to implement the cover 425 of the optical element cleaning mechanisms 400 and/or 500 is illustrated in FIG. 7. The cover 700 implements a movable diaphragm having multiple elements 705 arranged to form an aperture 710. The elements 705 can be implemented by one or more blades, plates, etc., and/or any other type(s) and/or combination of elements that are interleaved, interlocked and/or otherwise arranged to form the aperture 710. In the illustrated example, the aperture 710 is an opening whose size may be decreased and increased by one or more actuators (not shown) such that the size of the aperture 710 ranges, respectively, between a first (e.g., closed) position and a second (e.g., open) position.

Other types of cover technologies may be used to implement the cover 425 of the optical element cleaning mechanisms 400 and/or 500. For example, the cover 425 may be implemented using one or more hinged doors, plates, etc., and/or one or more sliding doors, plates, etc., and/or any other types of cover mechanisms or combination thereof.

While example manners of implementing the optical element cleaning mechanisms 400 and 500 have been illustrated in FIGS. 1-7, one or more of the elements, processes and/or devices illustrated in FIGS. 1-7 may be combined, divided, re-arranged, omitted, eliminated and/or implemented in any other way. Further, the example controller 460 and/or, more generally, the example optical element cleaning mechanisms 400 and/or 500 may be implemented by hardware, software, firmware and/or any combination of hardware, software and/or firmware. Thus, for example, the controller 460 and/or, more generally, the example optical element cleaning mechanisms 400 and/or 500 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example optical element cleaning mechanisms 400 and/or 500, and/or the controller 460 is/are hereby expressly defined to include a tangible computer readable storage device or storage disk such as a memory, a digital versatile disk (DVD), a compact disk (CD), a Blu-ray disk, etc. storing the software and/or firmware. Further still, the example optical element cleaning mechanisms 400 and 500 may include one or more elements, processes and/or devices in addition to, or instead of, those illustrated in FIGS. 1-7, and/or may include more than one of any or all of the illustrated elements, processes and devices.

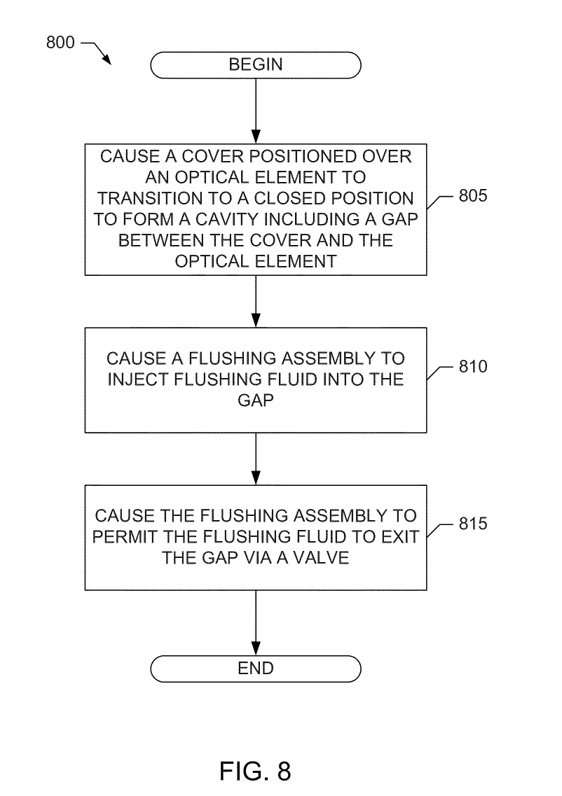

Flowcharts representative of example processes for implementing the example optical element cleaning mechanisms 400/500 and/or the example controller 460, and/or for controlling one or more of the example ultrasonic transducer(s) 420, the example cover 425, the example injector nozzle 440, the example exit nozzle 445 and/or the example valve 450, are shown in FIGS. 8-10. In these examples, the processes may be implemented by one or more programs comprising machine readable instructions for execution by a processor, such as the processor 1112 shown in the example processor platform 1100 discussed below in connection with FIG. 11. The one or more programs, or portion(s) thereof, may be embodied in software stored on a tangible computer readable storage medium such as a CD-ROM, a floppy disk, a hard drive, a digital versatile disk (DVD), a Blu-ray Disk™, or a memory associated with the processor 1112, but the entire program or programs and/or portions thereof could alternatively be executed by a device other than the processor 1112 and/or embodied in firmware or dedicated hardware (e.g., implemented by an ASIC, a PLD, an FPLD, discrete logic, etc.). Also, one or more of the processes represented by the flowcharts of FIGS. 8-10, or one or more portion(s) thereof, may be implemented manually. Further, although the example processes are described with reference to the flowcharts illustrated in FIGS. 8-10, many other methods of implementing the example optical element cleaning mechanisms 400/500 and/or the example controller 460, and/or for controlling one or more of the example ultrasonic transducer(s) 420, the example cover 425, the example injector nozzle 440, the example exit nozzle 445 and/or the example valve 450, may alternatively be used. For example, with reference to the flowcharts illustrated in FIGS. 8-10, the order of execution of the blocks may be changed, and/or some of the blocks described may be changed, eliminated, combined and/or subdivided into multiple blocks.

As mentioned above, the example processes of FIGS. 8-10 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 8-10 may be implemented using coded instructions (e.g., computer and/or machine readable instructions) stored on a non-transitory computer and/or machine readable medium such as a hard disk drive, a flash memory, a ROM, a CD, a DVD, a cache, a RAM and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended. Also, as used herein, the terms “computer readable” and “machine readable” are considered equivalent unless indicated otherwise.

A first example process 800 that may be executed to implement the example controller 460 to control the example optical element cleaning mechanisms 400 and/or 500 of FIGS. 4-5 is illustrated in FIG. 8. For convenience and without loss of generality, operation of the example process 800 is described from the context of being performed to control the optical element cleaning mechanism 400 of FIG. 4. With reference to the preceding figures and associated written descriptions, the example process 800 of FIG. 8 begins execution at block 805 at which the controller 460 issues one or more commands to cause the cover 425 of the optical element cleaning mechanism 400, which is positioned over the optical element 405, to transition to a first (e.g., closed) position to form a cavity (e.g., the cleaning area 435) having a gap (d) between the cover 425 and the optical element 405, as described above. At block 810, the controller 460 issues one or more commands to cause the injector nozzle 440 included in the flushing assembly of the optical element cleaning mechanism 400 to inject the flushing fluid 415 into the gap formed at block 805, as described above. At block 815, the controller 460 issues one or more commands to cause the exit nozzle 445 and/or the valve 450 of the flushing assembly of the optical element cleaning mechanism 400 to permit the flushing fluid, which was injected at block 810, to exit the gap formed at block 805, as described above.

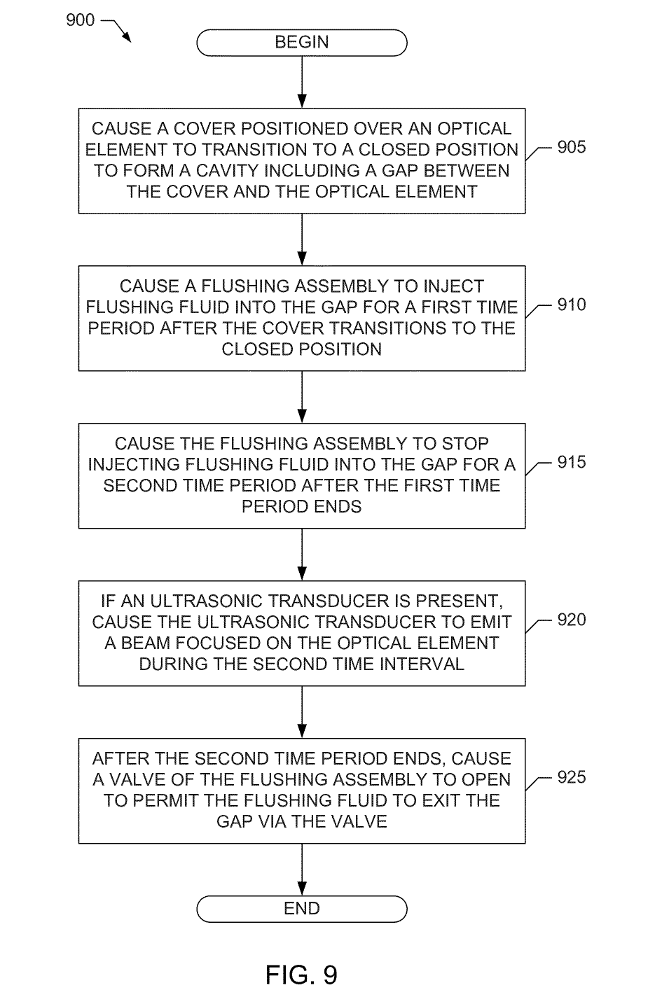

A second example process 900 that may be executed to implement the example controller 460 to control the example optical element cleaning mechanisms 400 and/or 500 of FIGS. 4-5 is illustrated in FIG. 9. For convenience and without loss of generality, operation of the example process 900 is described from the context of being performed to control the optical element cleaning mechanism 400 of FIG. 4. With reference to the preceding figures and associated written descriptions, the example process 900 of FIG. 9 begins execution at block 905 at which the controller 460 issues one or more commands to cause the cover 425 of the optical element cleaning mechanism 400, which is positioned over the optical element 405, to transition to a first (e.g., closed) position to form a cavity (e.g., the cleaning area 435) having a gap (d) between the cover 425 and the optical element 405, as described above.

Next, at block 910, the controller 460 issues one or more commands to cause the injector nozzle 440 included in the flushing assembly of the optical element cleaning mechanism 400 to inject the flushing fluid 415 into the gap formed at block 905. At block 910, the controller 460 causes the injector nozzle 440 to continue injecting the flushing fluid 415 into the gap for a first time period after the cover 425 transitions to the first (e.g., closed) position, as described above. At block 915, the controller 460 issues one or more commands to cause the injector nozzle 440 to stop injecting the flushing fluid 415 into the gap for a second time period after the first time period ends, as described above. At block 920, if one or more ultrasonic transducer(s) 420 are included in the optical element cleaning mechanism 400, the controller 460 issues one or more commands to cause the ultrasonic transducer(s) 420 to emit ultrasonic beam(s) focused on the optical element 405 during the second time interval, as described above.

After the second time period ends, at block 925 the controller 460 issues one or more commands to cause the exit nozzle 445 and/or the valve 450 of the flushing assembly of the optical element cleaning mechanism 400 to permit the flushing fluid, which was injected at block 910, to exit the gap formed at block 905, as described above. In some examples, at block 925 the controller 460 may also issue one or more commands to cause the injector nozzle 440 to inject further flushing fluid 415 to assist in removal of the contaminated flushing fluid from the gap.

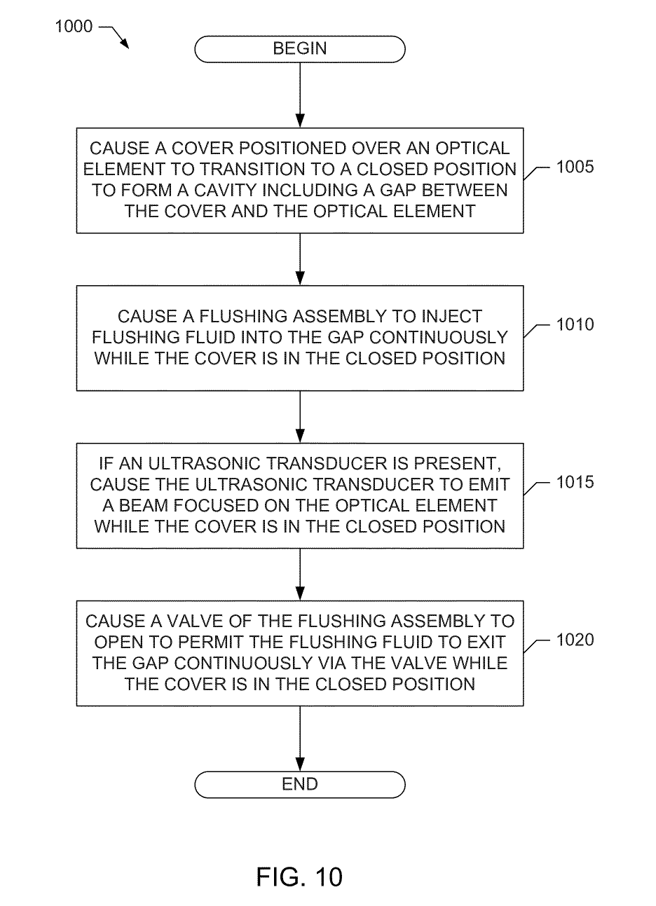

A third example process 1000 that may be executed to implement the example controller 460 to control the example optical element cleaning mechanisms 400 and/or 500 of FIGS. 4-5 is illustrated in FIG. 10. For convenience and without loss of generality, operation of the example process 1000 is described from the context of being performed to control the optical element cleaning mechanism 400 of FIG. 4. With reference to the preceding figures and associated written descriptions, the example process 1000 of FIG. 10 begins execution at block 1005 at which the controller 460 issues one or more commands to cause the cover 425 of the optical element cleaning mechanism 400, which is positioned over the optical element 405, to transition to a first (e.g., closed) position to form a cavity (e.g., the cleaning area 435) having a gap (d) between the cover 425 and the optical element 405, as described above.

Next, at block 1010, the controller 460 issues one or more commands to cause the injector nozzle 440 included in the flushing assembly of the optical element cleaning mechanism 400 to inject the flushing fluid 415 into the gap formed at block 1005 continuously (or almost continuously) while the cover 425 is in the first (e.g., closed) position, as described above. At block 1015, if one or more ultrasonic transducer(s) 420 are included in the optical element cleaning mechanism 400, then the controller 460 issues one or more commands to cause the ultrasonic transducer(s) 420 to emit ultrasonic beam(s) focused on the optical element 405 while the cover 425 is in the first (e.g., closed) position, as described above. Then, at block 1020, the controller 460 issues one or more commands to cause the exit nozzle 445 and/or the valve 450 of the flushing assembly of the optical element cleaning mechanism 400 to permit the flushing fluid, which was injected at block 1010, to exit the gap formed at block 1005 continuously (or almost continuously), as described above.

FIG. 11 is a block diagram of an example processor platform 1100 capable of executing the processes of FIGS. 8-10 to implement the example optical element cleaning mechanisms 400/500 and/or the example controller 460, and/or to control one or more of the example ultrasonic transducer(s) 420, the example cover 425, the example injector nozzle 440, the example exit nozzle 445 and/or the example valve 450 of FIGS. 1-7. The processor platform 1100 can be, for example, a server, a personal computer, a mobile device (e.g., a cell phone, a smart phone, a tablet such as an iPad™), a personal digital assistant (PDA), an Internet appliance, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors or controllers from any desired family or manufacturer.

The processor 1112 of the illustrated example includes a local memory 1113 (e.g., a cache) (e.g., a cache). The processor 1112 of the illustrated example is in communication with a main memory including a volatile memory 1114 and a non-volatile memory 1116 via a link 1118. The link 1518 may be implemented by a bus, one or more point-to-point connections, etc., or a combination thereof. The volatile memory 1114 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), and/or a PCI express interface.

In the illustrated example, one or more input devices 1122 are connected to the interface circuit 1120. The input device(s) 1122 permit(s) a user to enter data and commands into the processor 1112. The input device(s) can be implemented by, for example, a microphone, a camera (still or video), a keyboard, a button, a mouse, a touchscreen, a track-pad, a trackball, a trackbar (such as an isopoint), a voice recognition system and/or any other human-machine interface.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1120 of the illustrated example, thus, typically includes a graphics driver card, a graphics driver chip or a graphics driver processor.

The interface circuit 1120 of the illustrated example also includes a communication device such as a transmitter, a receiver, a transceiver, a modem and/or network interface card to facilitate exchange of data with external machines (e.g., computing devices of any kind) via a network 1126 (e.g., an Ethernet connection, a digital subscriber line (DSL), a telephone line, coaxial cable, a cellular telephone system, etc.).

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, RAID (redundant array of independent disks) systems, and digital versatile disk (DVD) drives.

Coded instructions 1132 corresponding to the instructions of FIGS. 8-10 may be stored in the mass storage device 1128, in the volatile memory 1114, in the non-volatile memory 1116, in the local memory 1113 and/or on a removable tangible computer readable storage medium, such as a CD or DVD 1136.

As an alternative to implementing the methods and/or apparatus described herein in a system such as the processing system of FIG. 11, the methods and or apparatus described herein may be embedded in a structure such as a processor and/or an ASIC (application specific integrated circuit).

Although a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

Finally, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. An apparatus to clean an optical element, the apparatus comprising:
a cover positionable over a first side of the optical element, the cover being controllable to transition between a first position and a second position, the cover forming a gap between a first side of the optical element and the cover when the cover is in the first position, the cover providing the optical element with access to a field-of-view when the cover is in the second position; and
a flushing assembly controllable to inject cleaning fluid into the gap when the cover is in the first position, the flushing assembly including a valve that is controllable to permit the cleaning fluid to exit the gap after having been injected into the gap.

2. An apparatus as defined in claim 1, wherein the flushing assembly further comprises:
a first nozzle through which the cleaning fluid is to be injected into the gap; and
a second nozzle through which the cleaning fluid is to exit the gap.

3. An apparatus as defined in claim 1, wherein the cover comprises a diaphragm controllable to change an aperture over the first side of the optical element, the diaphragm to increase a size of the aperture when the cover is controlled to transition from the first position to the second position, the diaphragm to decrease the size of the aperture when the cover is controlled to transition from the second position to the first position.

4. An apparatus as defined in claim 1, wherein the flushing assembly is controllable to:
inject the cleaning fluid into the gap for a first time period beginning after the cover has transitioned to the first position;
stop injection of the fluid into the gap for a second time period beginning after the first time period ends; and
open the valve to permit the cleaning fluid to exit the gap after the second time period ends.

5. An apparatus as defined in claim 1, wherein the flushing assembly is controllable to inject the cleaning fluid into the gap and to permit the cleaning fluid to exit the gap via the valve continuously after the cover has transitioned to the first position.

6. An apparatus as defined in claim 1, further comprising an ultrasonic transducer positionable to focus an ultrasonic beam on the first side of the optical element.

7. An apparatus as defined in claim 6, wherein the ultrasonic transducer is positioned on the cover and is arranged to focus the ultrasonic beam on the first side of the optical element when the cover is in the first position.

8. An apparatus as defined in claim 6, wherein the optical element is included in a housing, and the ultrasonic transducer is positioned on a wall of the housing.

9. An apparatus as defined in claim 6, wherein flushing assembly is controllable to:
inject the cleaning fluid into the gap for a first time period beginning after the cover has transitioned to the first position;
stop injection of the fluid into the gap for a second time period beginning after the first time period ends; and
open the valve to permit the cleaning fluid to exit the gap after the second time period ends, and wherein the ultrasonic transducer is controllable to:
emit the ultrasonic beam during the second time period.

10. An apparatus as defined in claim 6, wherein the flushing assembly is controllable to inject the cleaning fluid into the gap and to permit the cleaning fluid to exit the gap via the valve continuously after the cover has transitioned to the first position, and wherein the ultrasonic transducer is controllable to emit the ultrasonic beam after the cover has transitioned to the first position.

11. An apparatus as defined in claim 1, further comprising a heating element to heat the cleaning fluid prior to the cleaning fluid being injected into the gap.

12. An apparatus as defined in claim 1, wherein particles are mixed with the cleaning fluid prior to the cleaning fluid being injected into the gap.

13. An apparatus as defined in claim 1, wherein the optical element, the cover and the flushing assembly are included in a tool that is positionable downhole in a formation.

14. An apparatus as defined in claim 1, wherein the optical element comprises at least one of a lens, a window, a minor or a fiber optic cable.

15. An apparatus as defined in claim 1, wherein the cleaning fluid comprises at least one of water, air, a noncombustible gas or a solvent.

16. A method to clean an optical element, the method comprising:
electronically controlling a cover positioned over a first side of the optical element to cause the cover to transition from a second position providing the optical element with access to a field-of-view to a first position forming a gap between a first side of the optical element and the cover; and
electronically controlling a flushing assembly to cause the flushing assembly to (1) inject cleaning fluid into the gap when the cover is in the first position, and (2) permit the cleaning fluid to exit the gap via a valve after the cleaning fluid has been injected into the gap.

17. A method as defined in claim 16, wherein controlling the cover comprises controlling a diaphragm included in the cover to cause the diaphragm to decrease a size of an aperture over the first side of the optical element.

18. A method as defined in claim 16, wherein controlling the flushing assembly comprises causing the flushing assembly to perform operations comprising:
injecting the cleaning fluid into the gap for a first time period beginning after the cover has transitioned to the first position;
stopping injection of the fluid into the gap for a second time period beginning after the first time period ends; and
opening the valve to permit the cleaning fluid to exit the gap after the second time period ends.

19. A method as defined in claim 16, wherein controlling the flushing assembly comprises causing the flushing assembly to perform operations comprising injecting the cleaning fluid into the gap and permitting the cleaning fluid to exit the gap via the valve continuously after the cover has transitioned to the first position.

20. A method as defined in claim 16, further comprising controlling an ultrasonic transducer to cause the ultrasonic transducer to emit an ultrasonic beam focused on the first side of the optical element.
